(19) United States
(12) Patent Application Publication
(10) Pub. No.: US 2023/0032832 A1
(43) Pub. Date: Feb. 2, 2023

(54) LIQUID DISCHARGE APPARATUS AND CONTROL METHOD OF THE SAME

(71) Applicant: CANON KABUSHIKI KAISHA, Tokyo (JP)

(72) Inventors: Takahiro Itamoto, Kanagawa (JP); Tetsuyo Ohashi, Kanagawa (JP); Hiroshi Nakai, Kanagawa (JP); Sho Takahashi, Kanagawa (JP)

(21) Appl. No.: 17/869,329

(22) Filed: Jul. 20, 2022

(30) Foreign Application Priority Data
Jul. 27, 2021 (JP) 2021-122288

(51) Int. Cl. B41J 2/045; B41J 2/14

(52) U.S. Cl. CPC B41J 2/04563; B41J 2/04553; B41J 2/14

(57) ABSTRACT

A liquid discharge apparatus includes a head having a discharge part configured to discharge a liquid, and a shield member that is movable between a first position at which the shield member shields the discharge part and a second position at which the shield member exposes the discharge part in accordance with a temperature of the head.

### BACKGROUND OF THE INVENTION

### Field of the Invention

The present invention relates to a liquid discharge apparatus and a control method of the same.

### Description of the Related Art

There have been conventionally known liquid discharge apparatuses that include a head for discharging ink and a control mechanism for heating the head. Japanese Patent Application Laid-Open No. 2019-162860 discusses a configuration of a liquid discharge apparatus in which, if it is detected that the liquid discharge apparatus is lifted from a recording medium, a heater configured to heat a head is turned off to prevent the user from touching the head having a high temperature.

In the configuration of Japanese Patent Application Laid-Open No. 2019-162860, however, the user may touch the head still having a high temperature after the heater is turned off.

The present invention is made in view of the above-described issue, and is directed to providing a liquid discharge apparatus that prevents the user from touching a discharge part having a high temperature.

### SUMMARY OF THE INVENTION

According to an aspect of the present invention, a liquid discharge apparatus includes a head having a discharge part configured to discharge a liquid, and a shield member that is movable between a first position at which the shield member shields the discharge part and a second position at which the shield member exposes the discharge part in accordance with a temperature of the head.

Further features of the present invention will become apparent from the following description of exemplary embodiments with reference to the attached drawings.

### BRIEF DESCRIPTION OF THE DRAWINGS

FIGS. 1A and 1B are schematic views of a handy printer according to a first exemplary embodiment.

FIG. 2 is a block diagram illustrating a configuration of a control unit of the handy printer according to the first exemplary embodiment.

FIGS. 3A and 3B are schematic diagrams each illustrating a modification example of the handy printer according to the first exemplary embodiment.

FIGS. 4A and 4B are schematic views of a nail printer according to a second exemplary embodiment.

### DESCRIPTION OF THE EMBODIMENTS

Exemplary embodiments of the present invention will be described with reference to the drawings. However, the following exemplary embodiments do not limit the present invention, and all of combinations of features described in relation to the exemplary embodiments are not necessarily essential to the solutions of the present invention. Relative arrangements, shapes, and the like of constituent elements described in relation to the exemplary embodiments are mere examples and are not intended to limit the scope of the present invention to those arrangements, shapes, and the like. In the drawings, arrows X and Y indicate horizontal directions orthogonal to each other, and arrow Z indicates a vertical direction.

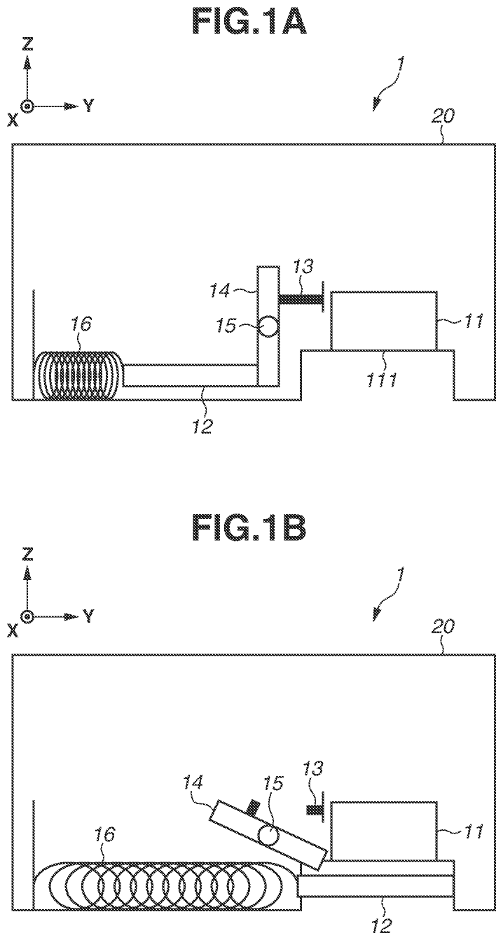

A first exemplary embodiment will be described. FIGS. 1A and 1B are schematic views of a handy printer 1 as an example of a liquid discharge apparatus. The handy printer 1 is a recording apparatus, for example, that can be hand-held by a user to record an image on a recording medium such as paper or cloth. The handy printer 1 includes a casing 20 as an exterior part and a head 11 that discharges a liquid (ink) to record an image on a recording medium.

The head 11 in the present exemplary embodiment includes a unit that generates thermal energy to be used for ink discharge (for example, a heat-generating resistance element), and the head 11 is of a type that causes a state change of the ink (film boiling) by the thermal energy. In this way, high density and high definition of image recording are achieved. The present invention is not limited to such a thermal-energy type but may be of a type that includes a piezoelectric transducer and utilizes vibration energy from the piezoelectric transducer.

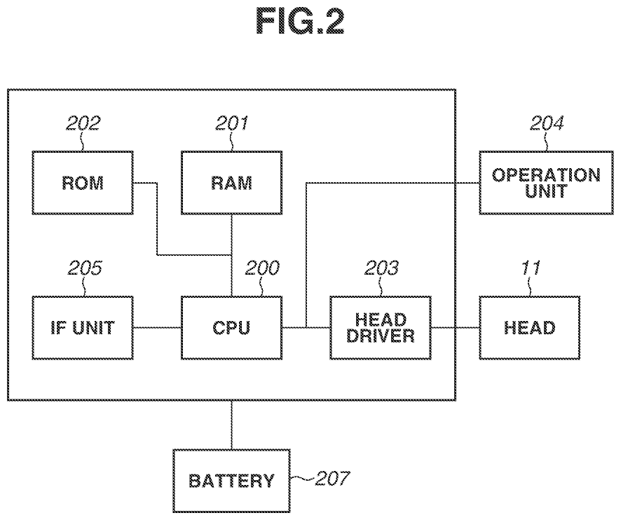

FIG. 2 is a block diagram illustrating a configuration of a control unit of the handy printer 1. A central processing unit (CPU) 200 executes control of the apparatus components and data processing. The CPU 200 executes a discharge operation by controlling data processing, driving of the head 11 and the like via the components described below in accordance with programs stored in a read only memory (ROM) 202.

The CPU 200 processes communication with a host apparatus via an interface (IF) unit 205. Image data is input from the outside via the IF unit 205. Connection with the external apparatus may be made in a wireless or wired manner or both of them. A random access memory (RAM) 201 is used by the CPU 200 as a work area for data processing and the like, and temporarily saves record data for several lines, parameters related to maintenance operations, and the like. A head driver 203 controls driving of the head 11 for discharging ink from the nozzle of the head 11.

An operation unit 204 enables a user to operate the handy printer 1. The operation unit 204 is an operation panel, for example, that is provided in the handy printer 1 and includes various switches and LEDs, buzzer, and the like. A battery 207 drives the handy printer 1 cordlessly.

As illustrated in FIGS. 1A and 1B, the handy printer 1 further includes a shutter 12, a fuse 13, a rotation member 14, and a spring 16. The shutter 12 is a shield member that can shield a nozzle surface 111 as a discharge part at which the nozzle of the head 11 is provided. FIG. 1A illustrates the shutter 12 at an opening position at which the shutter 12 does not shield the nozzle surface 111 of the head 11, and FIG. 1B illustrates the shutter 12 at a shield position at which the shutter 12 shields the nozzle surface 111 of the head 11. The fuse 13 may be a temperature fuse that automatically shuts off power distribution when a temperature of the fuse reaches a temperature higher than or equal to a predetermined temperature. In the present exemplary embodiment, the fuse 13 is attached to the head 11.

Under normal conditions where the head 11 is used for performing a discharge operation or the like, the shutter 12 is held by the spring 16, the rotation member 14, and the fuse 13 in an immovable manner, whereby the ink discharge from the head 11 is not hindered. The spring 16 is an example of a biasing unit that biases the shutter 12 toward the shield position. The rotation member 14 is held so as not to make a rotational motion due to a balance between tensile force (biasing force) from the spring 16 and the fuse 13. The rotation member 14 functions as a regulation unit that regulates the movement of the shutter 12 in a state where the rotation member 14 is held.

In the present exemplary embodiment, in a case where the temperature of the head 11 excessively increases in the state illustrated in FIG. 1A, the fuse 13 blows out and the rotation member 14 rotates around a rotation shaft 15. Accordingly, the shutter 12 is freed from the movement regulation by the rotation member 14, and the shutter 12 moves in the Y direction under tensile force of the spring 16 and comes to the shield position where the shutter 12 shields the head 11. By virtue of the configuration, the user is prevented from touching the head 11 having a high temperature.

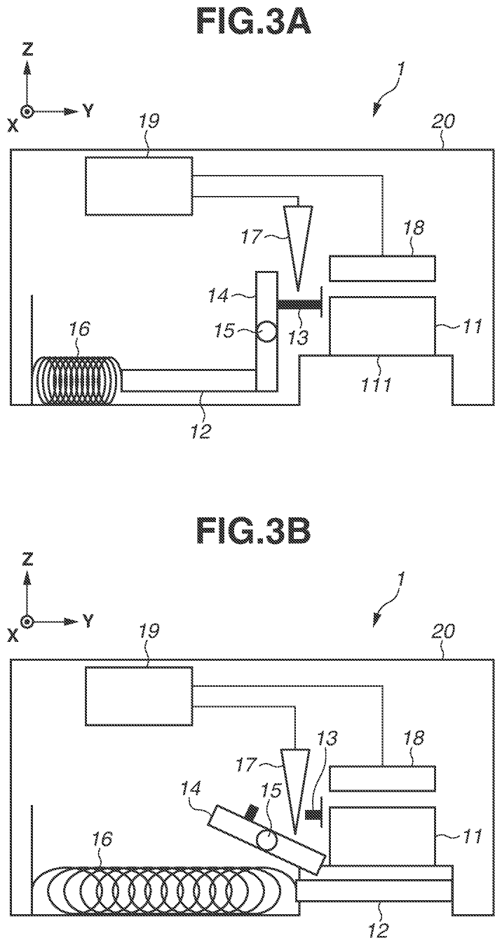

FIGS. 3A and 3B are schematic diagrams each illustrating a modification example of the handy printer 1 in the present exemplary embodiment. FIG. 3A illustrates the shutter 12 at the open position at which the shutter 12 does not shield the nozzle surface 111 of the head 11, and FIG. 3B illustrates the shutter 12 at the shield position at which the shutter 12 shields the nozzle surface 111 of the head 11.

The handy printer 1 in the present modification example further includes a cutter 17, a temperature sensor 18 as a temperature detection unit, and a cutter driving motor 19. Under normal conditions where the head 11 is used for performing a discharge operation or the like, the cutter 17 is held at a position at which the cutter 17 does not cut the fuse 13.

In a case where the temperature of the head 11 abnormally increases in the state illustrated in FIG. 3A, the temperature sensor 18 provided around the head 11 detects the abnormal temperature increase.

In a case where the temperature sensor 18 detects the abnormal temperature increase, the cutter driving motor 19 drives the cutter 17 to move and cut the fuse 13 as illustrated in FIG. 3B. This causes the rotation of the rotation member 14, and the shutter 12 is moved in the Y direction under tensile force of the spring 16 and comes to the shield position at which the shutter 12 shields the nozzle surface 111 of the head 11. In this manner, also by virtue of the configuration of the modification example, the user is prevented from accessing the head 11 having a high temperature.

The activation unit of the shutter 12 is not limited to the fuse 13, and any material capable of moving the shutter 12 again to the open position by cooling the head 11 may be used. In this way, the handy printer 1 can be continuously used without replacement of the components.

The fuse 13 may be configured to deform when the fuse 13 directly senses an abnormal increase in the temperature of the head 11 or may be configured to deform when the fuse 13 senses an increase in the temperature of a surrounding member or surrounding air due to the abnormal increase in the temperature of the head 11.

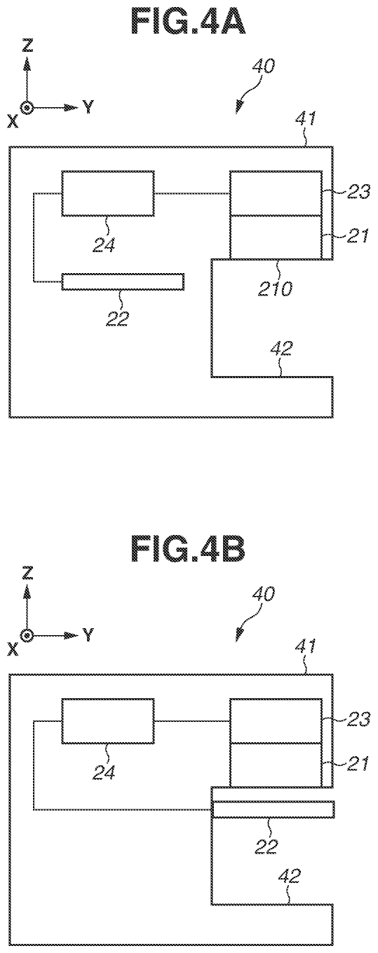

A second exemplary embodiment will be described. FIG. 4 is a schematic diagram illustrating a skeleton configuration of a nail printer 40 as an example of a liquid discharge apparatus. The nail printer 40 includes a casing 41 as an exterior part, a head 21 that discharges a liquid (ink) to record images on a user's nails, and a platform 42 on which the user's hands and fingers can be placed. As with the handy printer 1 described above in the first exemplary embodiment, the nail printer 40 includes a CPU 200, a RAM 201, a ROM 202, a head driver 203, an operation unit 204, an IF unit 205, and the like.

In the present exemplary embodiment, the head 21 includes a unit that generates thermal energy to be used for ink discharge (for example, a heat-generating resistance element), and is of a type that causes a state change of the ink (film boiling) by the thermal energy. In this way, high density and high definition of image recording can be achieved. The present invention is not limited to such a thermal-energy type but may be of a type that includes a piezoelectric transducer and utilizes vibration energy from the piezoelectric transducer.

The nail printer 40 further includes, as a head shield mechanism, a shutter 22, a driving unit 24 that drives the shutter 22, and a temperature sensor 23 that detects the temperature of the head 21. FIG. 4A illustrates the shutter 22 at the open position at which the shutter 22 does not shield a nozzle surface 210 of the head 21, and FIG. 4B illustrates the shutter 22 at the shield position at which the shutter 22 shields the nozzle surface 210 of the head 21. The temperature sensor 23 may not be configured to directly detect an abnormal increase in the temperature of the head 21 but may be configured to detect an increase in the temperature of a surrounding member or surrounding air due to the abnormal increase in the temperature of the head 21.

As illustrated in FIG. 4A, under normal conditions where the head 21 is used for performing a discharge operation or the like, the shutter 22 is held at an open position at which the shutter 22 does not hinder ink discharge from the head 21. In a case where the temperature sensor 23 detects an abnormal increase in the temperature of the head 21 in the state illustrated in FIG. 4A, the driving unit 24 drives the shutter 22 to move in the Y direction. Accordingly, the shutter 22 comes to a shield position at which the shutter 22 shields the head surface 210 of the head 21.

By virtue of the configuration, the user is prevented from touching the head 21 having a high temperature.

In this manner, the present invention can provide an apparatus with higher usability when the apparatus is employed in a liquid discharge apparatus in which the user can easily access the nozzle surface of the head, such as a handy printer or a nail printer, for example.

According to the present invention, there is provided a liquid discharge apparatus that prevents the user from touching a discharge part having a high temperature.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021- 122288, filed Jul. 27, 2021, which is hereby incorporated by reference herein in its entirety.

What is claimed is:

1. A liquid discharge apparatus comprising:
a head having a discharge part configured to discharge a liquid; and
a shield member that is movable between a first position at which the shield member shields the discharge part and a second position at which the shield member exposes the discharge part in accordance with a temperature of the head.

2. The liquid discharge apparatus according to claim 1, further comprising:
a temperature detection unit configured to detect the temperature of the head,
wherein the shield member is moved from the second position to the first position based on detection of the temperature by the temperature detection unit.

3. The liquid discharge apparatus according to claim 1, further comprising:
a regulation unit configured to regulate movement of the shield member from the second position to the first position,
wherein the regulation unit regulates the movement of the shield member to keep the shield member at the second position.

4. The liquid discharge apparatus according to claim 3,
wherein the regulation unit is movable to a third position at which the regulation unit regulates the movement of the shield member and to a fourth position at which the regulation unit does not regulate the movement of the shield member, and
wherein, in a case where the regulation unit is at the fourth position, the shield member is moved from the second position to the first position.

5. The liquid discharge apparatus according to claim 3,
wherein the regulation unit is kept at the third position by a fuse configured to blow out at a temperature higher than or equal to a predetermined temperature, and
wherein, in a case where the fuse blows out, the regulation unit is moved from the third position to the fourth position.

6. The liquid discharge apparatus according to claim 2, further comprising:
a fuse configured to keep the regulation unit at the third position; and
a cutting unit configured to cut the fuse,
wherein the cutting unit cuts the fuse based on the information from the temperature detection unit.

7. The liquid discharge apparatus according to claim 6, wherein, in a case where the cutting unit cuts the fuse, the regulation unit is moved from the third position to the fourth position.

8. The liquid discharge apparatus according to claim 1, further comprising:
a biasing unit configured to bias the shield member in a direction in which the shield member is moved from the second position to the first position.

9. The liquid discharge apparatus according to claim 2, further comprising:
a driving unit that is driven based on information from the temperature detection unit to move the shield member from the second position to the first position.

10. The liquid discharge apparatus according to claim 1, wherein the liquid discharge apparatus is a handy printer configured to be used by a user to perform scanning so as to discharge a liquid from the discharge part to form an image on a recording medium.

11. The liquid discharge apparatus according to claim 1, wherein the liquid discharge apparatus is a nail printer configured to discharge a liquid from the discharge part to record an image on a user's nail.

12. The liquid discharge apparatus according to claim 1, wherein the shield member is moved from the second position to the first position in accordance with an increase in the temperature of the head.

13. A liquid discharge apparatus comprising:
a head having a discharge part configured to discharge a liquid;
a shield member that is movable to a first position at which the shield member shields the discharge part and to a second position at which the shield member exposes the discharge part; and
a movement unit configured to move the shield member so as to place the shield member at the second position in a case where the temperature of the head is a first temperature, and to place the shield member at the first position in a case where the head is a second temperature higher than the first temperature.

14. A liquid discharge method for a liquid discharge apparatus, the liquid discharge method comprising:
discharging the liquid from a discharge part configured to discharge a liquid included in a head; and
moving the shield member that is movable to a first position at which the shield member shields the discharge part and to a second position at which the shield member exposes the discharge part, between the second position and the first position in accordance with a temperature of the head.

15. The liquid discharge method according to claim 14, wherein the shield member is moved based on detection of the temperature by a temperature detection unit configured to detect the temperature of the head or the temperature of the surroundings of the head.

16. A liquid discharge method for a liquid discharge apparatus including a head having a discharge part configured to discharge a liquid, and a shield member that is movable to a first position at which the shield member shields the discharge part and to a second position at which the shield member exposes the discharge part, the liquid discharge method comprising:
discharging the liquid from the discharge part: and
moving the shield member to the second position in a case where the temperature of the head is a first temperature, and moving the shield member to the first position in a case where the temperature of the head is a second temperature higher than the first temperature.
